(19) United States
(12) Patent Application Publication
(10) Pub. No.: US 2003/0137988 A1
(43) Pub. Date: Jul. 24, 2003

(54) Demand-based weighted polling algorithm for communication channel access or control

(76) Inventor: Frederick Enns, Menlo Park, CA (US)

Correspondence Address: Lawrence Harbin, McIntyre Harbin & King, Suite 330, One Massachusetts Avenue, N.W., Washington, DC, 20001, US

(21) Appl. No.: 10/223,699

(22) Filed: Aug. 20, 2002

Related U.S. Application Data
(60) Provisional application No. 60/313,109, filed on Aug. 20, 2001.

(51) Int. Cl. H04L 12/413

(52) U.S. Cl. 370/455; 370/449

(57) ABSTRACT

A method of allocating upstream transmission resources in a communication network based on indications of data transfer need includes monitoring client requests or transmission activity, ordering grants of the upstream channel access according to indications of need, and granting upstream access according to such ordering. After being granted access, clients are re-ordered by repeating the foregoing steps. Ordering may be accomplished by assigning to clients a time-to-access based on their respective indication of need and granting priority to the client with the smallest time. Indications of client need may be based on data actually transferred or queued for transfer, average rates of data transfer which may or may not be weighted according to increasing or decreasing indications of need from the client, or a host of other variations that reflect indications of need, ordering, and re-ordering. A corresponding apparatus is also disclosed.

### CROSS-REFERENCE TO RELATED APPLICATION

This invention claims the benefit of Provisional Application No. 60/313,109 entitled Demand-Based Weighted Polling Algorithm For Communication Channel Access or Control, which was filed Aug. 20, 2001, in the name of the inventor hereof The subject matter thereof is hereby incorporated by reference.

### BACKGROUND

This invention relates to a method and an apparatus for accessing or transferring data over a communication channel in a data communication network.

In many communication networks difficulties arise from a finite capacity of the medium to meet the demand of multiple clients sharing a common network. In a networked system, individual clients do not usually have benefits of a dedicated transmission medium. Challenges to obtaining unrestricted throughput take many forms, one of which involves multiple clients attempting to transmit upstream information to a central unit over the same medium. In the prior systems solutions to this problem include devising various contention protocols, round robin access, and general polling to provide fair or a distributed access to the shared transmission medium. Each of these schemes encounter difficulties under different conditions. Contention protocols tend to perform well under light client usage, but as loading increases, performance tends to decrease as more data collisions occur. Polling and round robin medium access perform well under heavy loading since data collisions are eliminated, but under light loading, both tend to show a lower performance as transmission time is wasted on non-responsive users and/or users not needing the transmission resource.

All three medium access methods: polling, round robin, and contention, do not dynamically or readily adapt to the changing upstream demand of the individual client devices. Accesses afforded to client devices tend to be ordered chronologically according to their time of activation on the channel regardless of the amount of information needing to be transmitted. For example, in a contention protocol scheme, back-off times may be assigned according to the time the client attempted to access the channel, sometimes allowing clients with a lower quantity of information to transmit ahead of the clients who have higher amounts of information.

A difficulty in dynamically adapting to client demand and allocating the upstream transmission resources accordingly results in fewer clients being serviced by the system, a waste the transmission resources by either overserving or underserving the client, and results in, for high upstream users, an increased period of delay in upstream packet transmission and subsequent downstream response.

Prior systems utilizing an architecture of a combination of transmission channel types and protocol that helps determine client status (e.g., responsive/unresponsive) has been used in conjunction with a variety of access type protocols to help decrease inefficiencies from nonresponsive clients and attempt to adjust to the demands of the client.

In view of the foregoing, it is desirable to develop a method and a system that better allocates transmission resources (e.g., transmission time) under both heavy and light client usage and that dynamically adapts to the demand of the individual client or clients. Those skilled in the art may appreciate the benefit of increasing the number of clients able to be serviced by the existing network system while simultaneously increasing the quality of the service to the clients, as expressed, for example, in decreased delays for high upstream clients while keeping low data rate upstream clients at the same if not improved level of service.

### SUMMARY

In accordance with an aspect of the present invention, there is provided a method for use in a bi-directional communication network that provides upstream data transfers for multiple clients over a shared upstream channel, a method of allocating access to said shared channel comprising monitoring the clients to obtain indications of need of respective ones of the clients for upstream channel access, ordering grants of upstream channel access to respective ones of said clients based on said indications, granting upstream channel access to one client according to the ordering step, and re-ordering grants of channel access to respective ones of said client after said one client obtains access to the shared upstream channel by repeating the prior steps.

In accordance with another aspect of the invention, there is provided an apparatus for controlling allocation of access to a shared upstream channel in a network that provides via a controller bi-directional communication over upstream and downstream data transfer channels for a plurality of clients, wherein the controller monitors the clients to obtain indications of need of respective ones of the clients for upstream channel access, orders grants of upstream channel access to respective ones of said clients based on said indications, grants upstream channel access to one client according to the ordering of the plurality of clients, and reorders grants of channel access to respective ones of said client after controller grants said one client access to the shared upstream channel by repeating the prior steps.

These and other aspects of the invention will become apparent upon review of the following description taken in connection with the accompanying drawings. The invention, though, is pointed out with particularity by the appended claims.

### BRIEF DESCRIPTION OF THE DRAWINGS

FIG. 1 is a simplified flowchart indicating monitoring of the clients for indications of need and adjusting the clients' access to the upstream channel according to indications of need.

FIG. 2 is a flow chart reflecting another embodiment of the invention where upstream client access is controlled.

FIG. 3 depicts an aspect of a method that determines a sliding window average of data transfer and using the average as an indication of need for controlling upstream medium access.

FIG. 4 depicts a method initializing an assigned time parameter to clients based on their indication of need.

FIG. 5 is an illustration detailing a time initialization method.

FIG. 6 illustrates ordering of clients based on their time initialization.

FIG. 7 is a diagram showing ordering of clients around the grants of upstream access.

FIG. 8 is a diagram showing ordering of grants of access around the clients.

FIG. 9 is a flow chart describing control of upstream channel access by reordering clients.

FIG. 10 is a flow chart describing a method including a step decrementing client positions in the ordering process.

FIG. 11 illustrates a variation of the method depicted in FIG. 10 including decrementing the time parameter allocated to the clients.

FIG. 12 is a flow chart illustrating a method for removing clients granted upstream access and for reinserting the removed clients back into ordered access scheme.

FIG. 13 illustrates a method combining the time-to-access parameter assignment and removing the client after being granted upstream access methods.

FIG. 14 is a flowchart illustrating the application of the method for the movement of clients between channel types.

FIG. 15 is a flowchart illustrating the movement of clients between channel types in a network including at least one shared upstream channel and at least one dedicated upstream channel.

FIG. 16 is a flow chart illustrating movement of clients between shared, dedicated, and contention channels.

FIG. 17 illustrates a prior polling method showing individual clients, different steps in the prior method, and the effects of each step on the clients.

FIGS. 18A and 18B illustrates an embodiment of the improved method explicitly showing the individual clients.

FIG. 19 illustrates an improvement in ordering of a newly appearing client as contrasted with a prior polling method.

FIG. 20 illustrates the return of active clients to a stack for re-ordering.

FIG. 21 shows a schematic drawing of a network and placement of the upstream channel access allocation controller apparatus within the network.

### DESCRIPTION OF ILLUSTRATIVE EMBODIMENTS

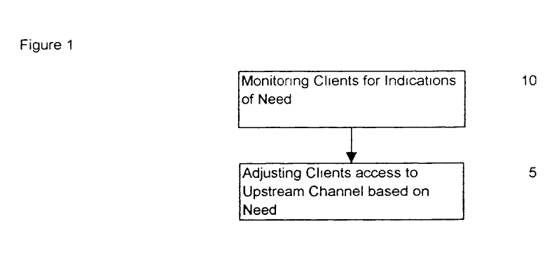

The invention comprises an improved method and system of allocating upstream transmission resources to multiple clients that share a communication network. The method shown in FIG. 1 illustrates at step 10 of monitoring of client devices for indications of a need for upstream channel resources and a step 5 of adjusting the clients' access to the upstream channel based on the indications of need.

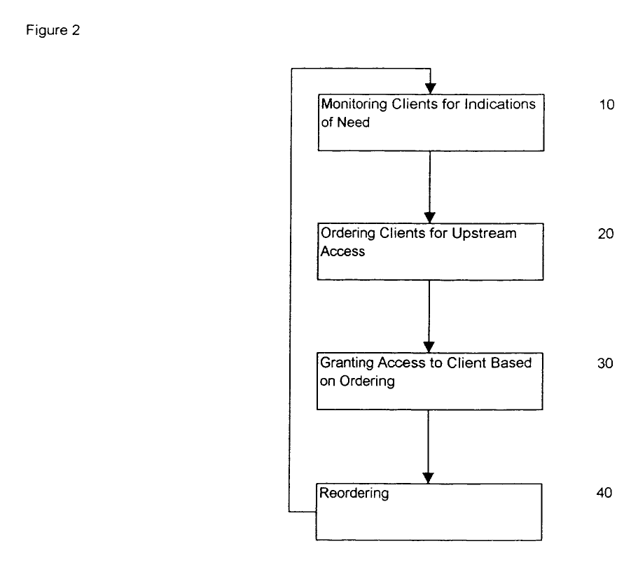

FIG. 2 is a flow chart outlining an aspect of a process series of the invention. The clients on a network are monitored at step 10 in order to obtain an indication of need for upstream channel access. After monitoring, an ordering step 20 orders the clients according to their indication of need and grants of upstream channel access are allocated accordingly. Upstream access is then granted at step 30 to a client based on the ordering. After the upstream access is granted, a re-ordering step 40 occurs by repeating the monitoring 10, ordering, 20 and granting 30 steps.

The indication monitored may be information units, for example bytes or IP packets. The indications monitored may have been data transferred upstream, or information units that have been indicated or queued for upstream transfer. If along with the upstream transmission an information unit that represents the number of information units remaining generally to be transferred is sent, this information unit may be used for the indication of need for upstream channel access.

The indication of need monitored may be an instantaneous quantity, such as the information units transferred from the upstream transmission, or in a variation on the method, an average of the data transmissions from the client.

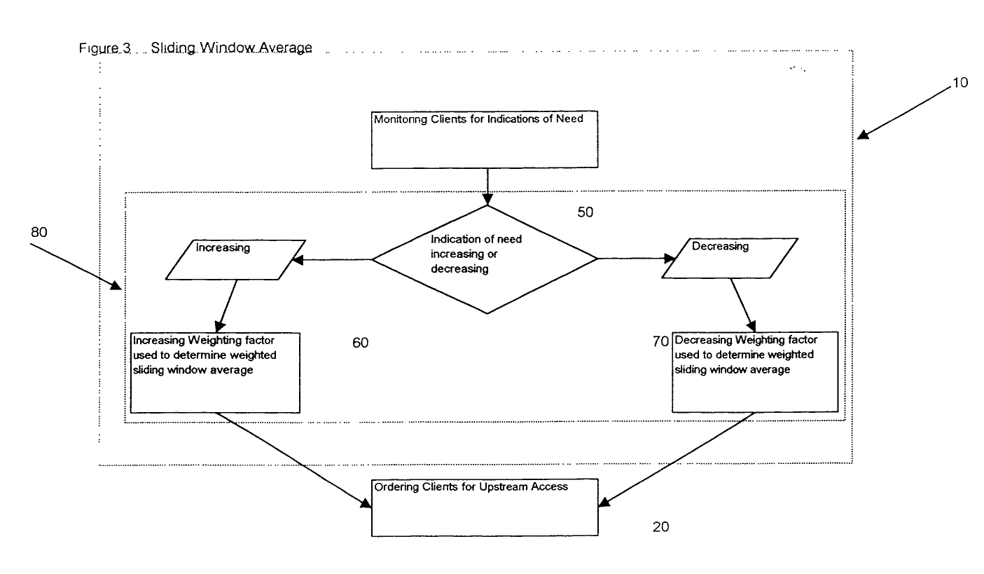

FIG. 3 illustrates an aspect of the method, which determines a sliding window average of the data transfer and uses the average as an indication of need. A sliding window average is determined as an average data transfer within a given time window and the average is somewhat dynamic and determined upon successive transfers of data. In one of several embodiments of the invention, the sliding window average 50 is weighted according to whether the sliding window average 50 is increasing or decreasing 60. The sliding window average may be defined as an instantaneous upstream data transfer or amount queued for transfer. The sliding window average, in another variation of the method, may also be weighted according to whether the sliding window average 50 is increasing or decreasing 60.

As previously described, grants of access to the clients in step 30 (FIG. 2) are ordered at step 20 (FIG. 2) by the client's indication of need. Using the example of the sliding window average as a monitored indication of need, the clients may be ordered at step 20 according to their respective sliding window averages. The clients may be ordered according to the instantaneous indications of need, or may be ordered according to an average of these indications. One variation of the method determines the sliding window average indication of need at step 80 (FIG. 3) and orders the client at step 20 (FIG. 2) in relation to other clients using the sliding window average.

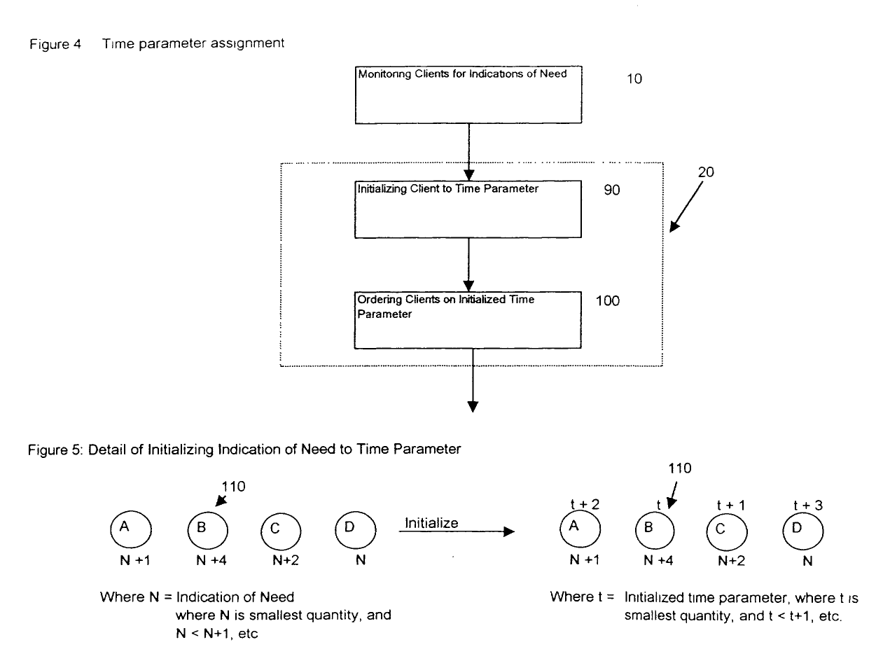

FIG. 4 illustrates an arrangement of a method of ordering of clients. The arrangement includes monitoring clients for indications of need at step 10 and assignsing a time parameter at step 90 to the clients based on their respective indication of need. This time parameter is used as an ordinal device at step 100.

FIG. 5 is an illustration of a time initialization aspect of the invention. The client 110 with the greatest indication of need receives the smallest time allocation. FIG. 6 illustrates a method where the client 110 with the smallest time allocation obtains priority by being repositioned at client position 120 to the upstream channel grant. This time parameter of the client, in an alternative embodiment of the invention, may be a measurement of the time-to-access the upstream channel.

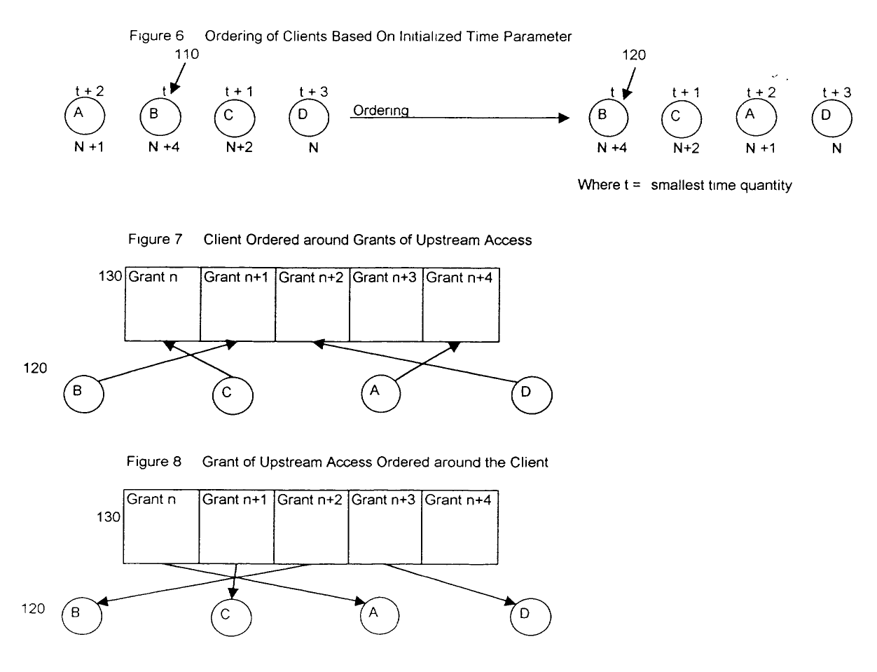

FIG. 7 illustrates a method of ordering grants of upstream access to client devices. In one embodiment, clients 120 is ordered around Grants n, Grant n+1, Grant n+3, etc. of upstream access shown at 130. FIG. 8 illustrates a similar method, but where the grants of upstream access 130 are ordered around the clients 120.

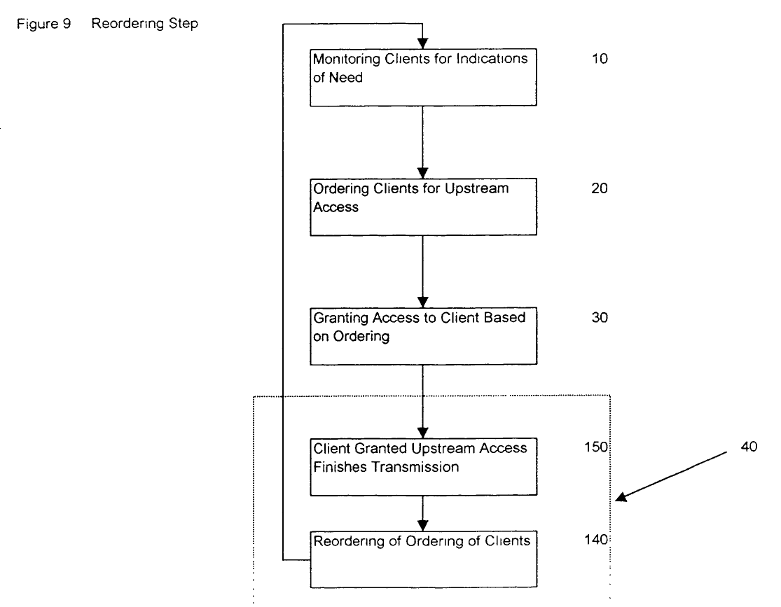

FIG. 9 is a flow chart describing re-ordering. Access to the upstream channel is granted to clients according to the ordering performed at step 30. Reordering step 140, in one variation of the method, may begin after the client granted upstream channel access completes its upstream data transfer at step 150.

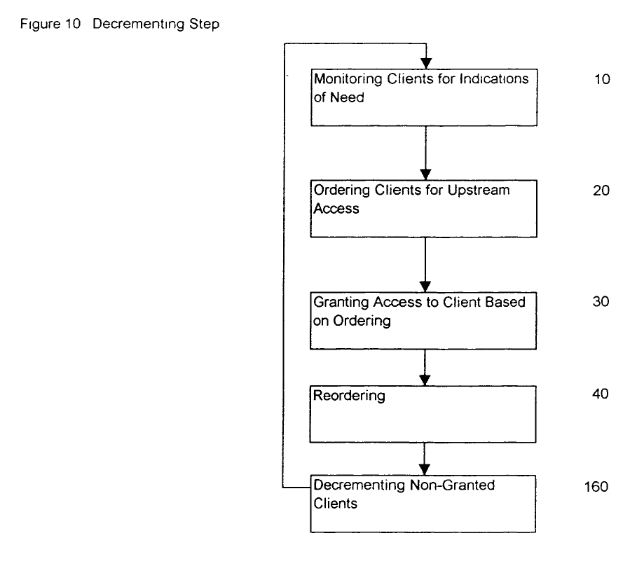

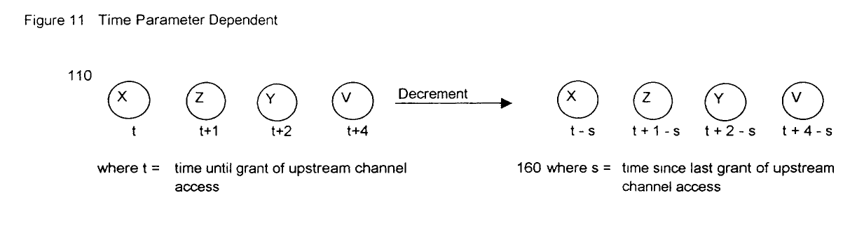

FIG. 10 is a flowchart describing an embodiment of the invention including a decrementing step 160. In one variation the time-to-access is decremented, in another, simply the positions of the clients are decremented.

FIG. 11 illustrates a variation of the method comprising decrementing the time parameter allocated to the clients. The time parameter of each client 110 may be decremented by the time-to-access 160 since the last grant of upstream access to a client.

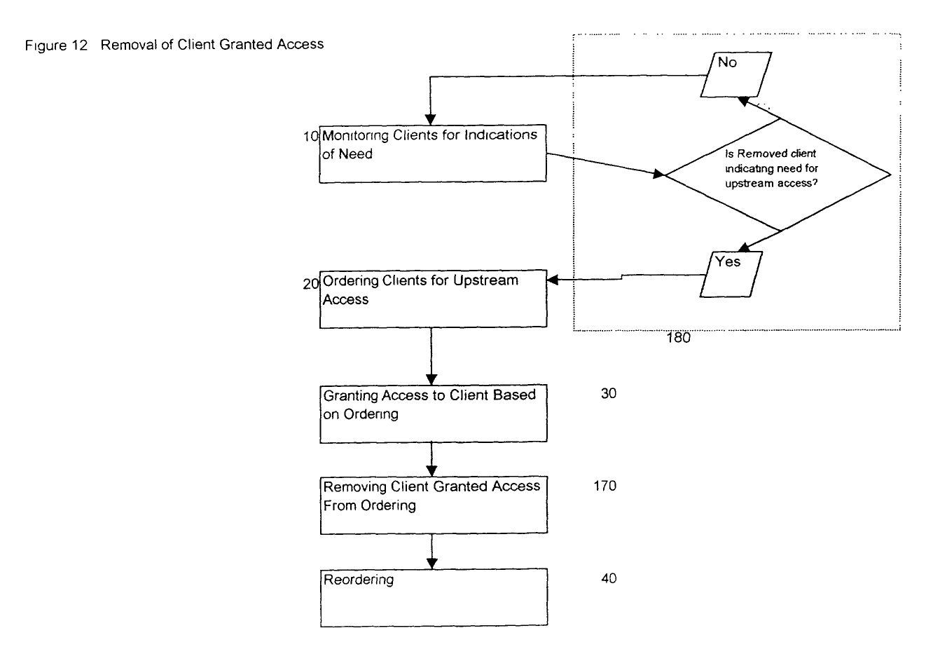

FIG. 12 describes an embodiment of the method of removing clients granted upstream access. This method removes a client granted access at step 170 and reorders the clients at step 40. In the reordering process the client granted access is not reordered, as is not a part of the ordering, but may, in another embodiment of the method, be reinserted at step 180 into the ordering upon an indication of need for the upstream access.

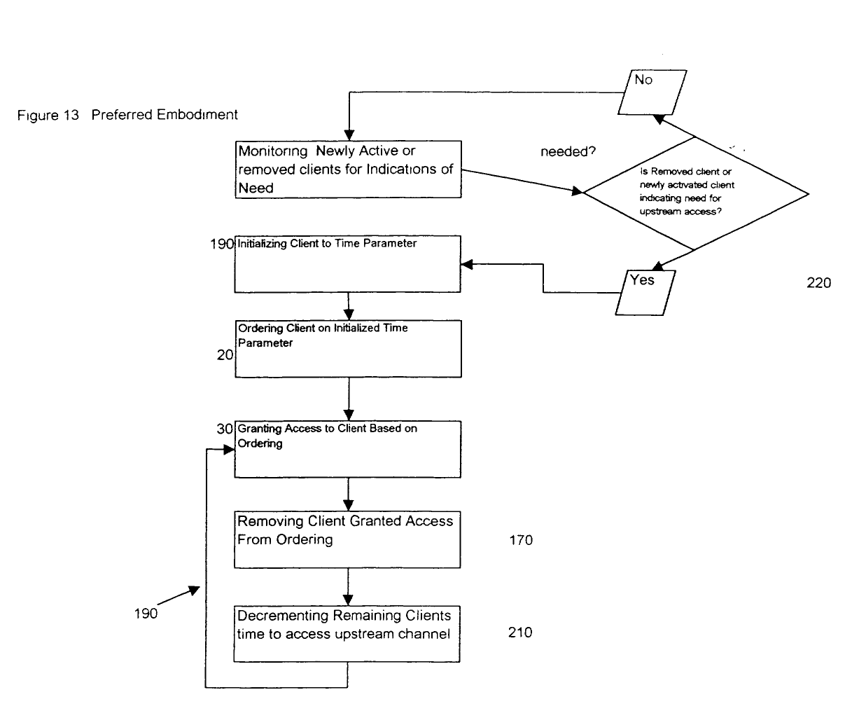

FIG. 13 describes a preferred structure of the method combining the time-to-access parameter assignment and the removing the client after being granted upstream access embodiment. The clients, once assigned a time-to-access parameter 190 and sorted in the ordering of clients at step 20, are not reordered relative to each other in the ordering. Only clients returning to the ordering stack after a grant of access at step 220 or newly active clients to the ordering are assigned a new time-to-access parameter, at step 190 sorted, placed in the ordering at step 20 according to their time parameter. For the other clients already in the ordering, the method decrements at step 210 the time-to-access parameter.

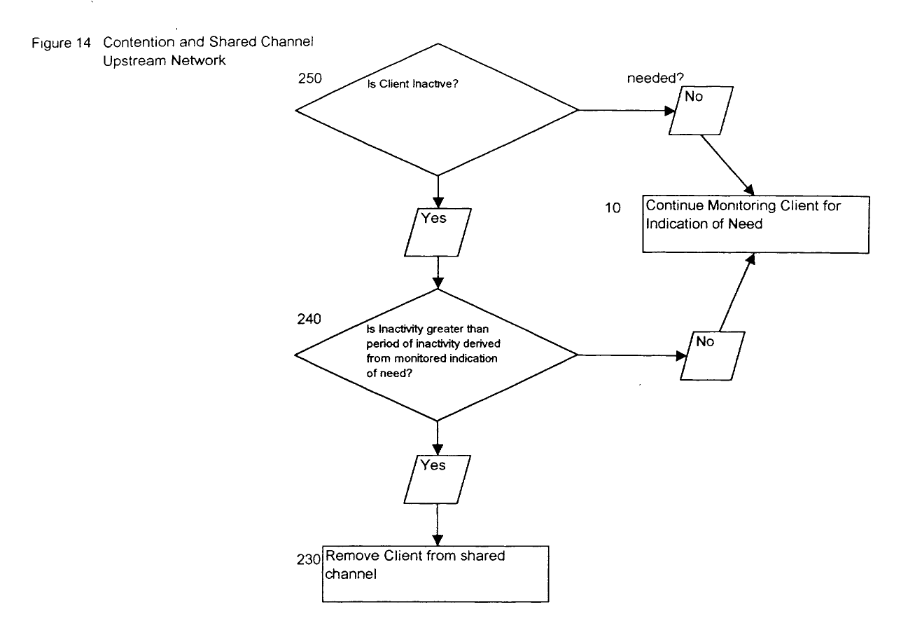

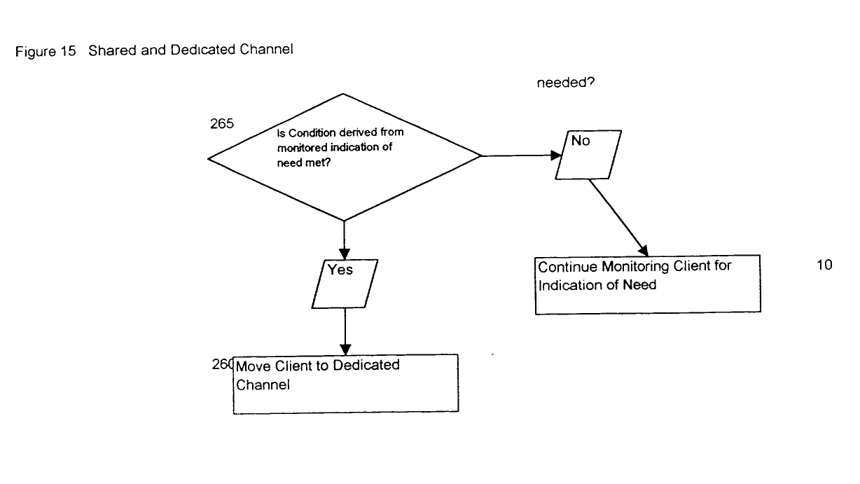

FIG. 14 is a flow chart for an aspect of the method disclosing movement of clients between channel types. In a communication network including a shared upstream channel and a contention upstream channel on which multiple clients contend for authorization to obtain upstream channel access, a variation of the method includes determining whether the client is inactive through monitoring for an indication of need or similar method. If the client is inactive, the client is removed at step 230 from the shared channel after a given period of inactivity derived from the monitored indication of need at step 240.

FIG. 15 is another flow chart showing movement of a client between channel types. In a communication network including at least one shared upstream channel and at least one dedicated upstream channel, a variation of the method includes moving a client from the shared channel to a dedicated channel at step 260 in response to a condition derived from the monitored indication of need for that client at step 250.

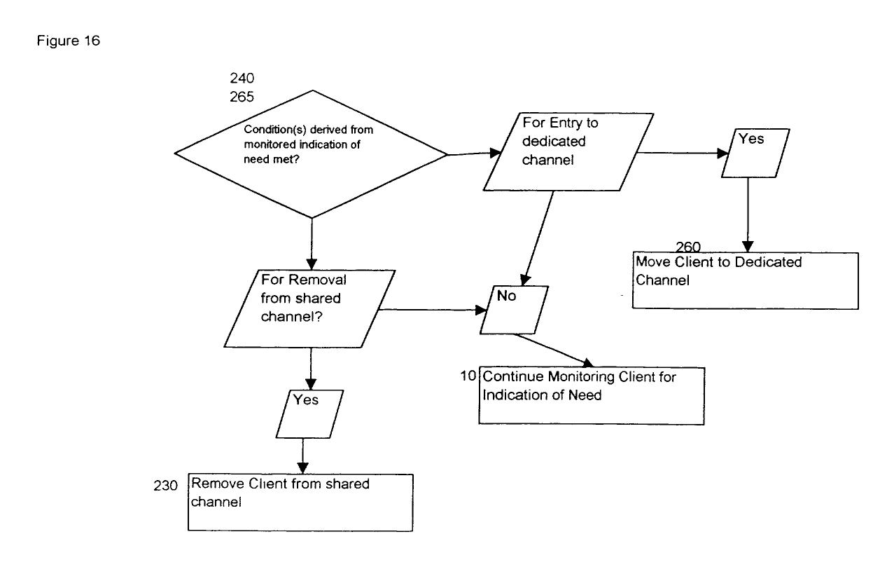

FIG. 16 is a flow chart showing moving a client between or among a shared, contention, and dedicated channel. A variation of the method is also illustrated when a network contains at least one shared, contention, and dedicated channel, and the client is removed at step 230 from or moved to one of the other channel types at step 260 in response to a condition detected at step 240, 265 based on the monitored indication of need from the client.

The client may remain on a dedicated channel for a fixed or varying amount of time.

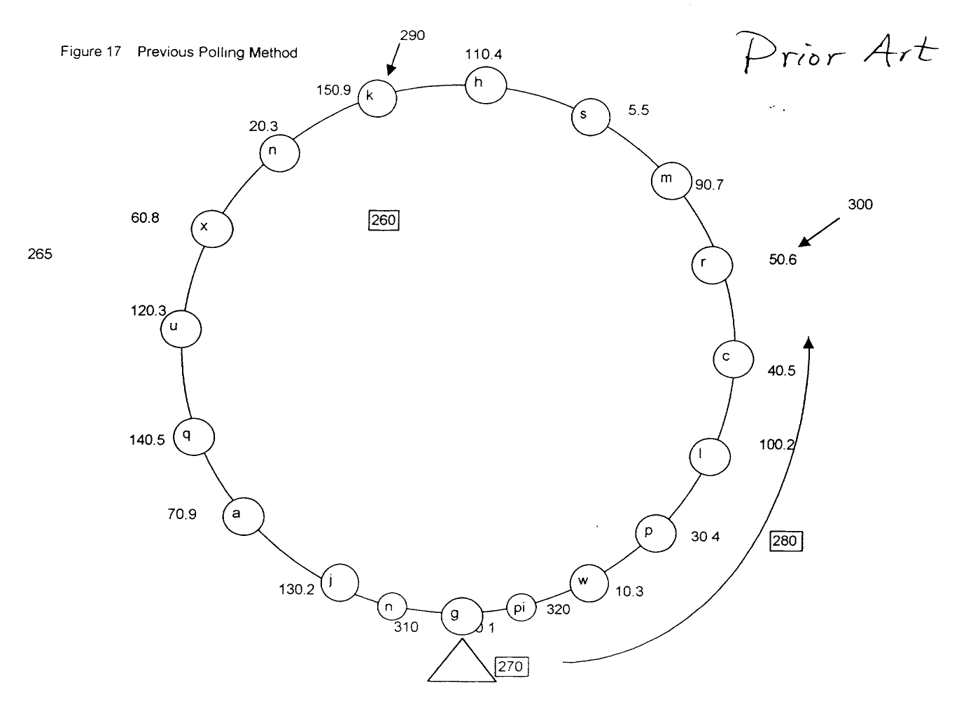

In describing FIGS. 17-19, a prior polling method may be contrasted with embodiments of improved methods to help clarify the invention. The prior polling method of FIG. 17 shows ordering that may be viewed as a circle 260 of clients awaiting upstream access arranged in chronological order as to the appearance or return of the client to the circle of awaiting clients 260. The circle analogy is used here in an illustrative sense only, other views may be equally correct in describing a polling scenario. The arrangement of the clients is independent of their indication of need. The indication of need may comprise rates or quantities, such as IP packets/seconds or bytes/second, etc. The pointer 270 indicates the client last receiving the grant of upstream transmission. The pointer advances 280 after the grantee client finishes its upstream transmission, with the next client receiving a grant of upstream transmission access. The clients are removed from the circle and not granted upstream transmission after a given time of inactivity, time out period, or number of pollings.

Ordering of clients is neither sensitive nor dynamic in adjusting to the client's need for upstream access. Inevitably some of the clients are granted a channel when they have little to no upstream transmission need at that moment but have enough of a need that they are not removed from the shared channel (do not extend past the time-out period). Other clients may indicate a large need 290 for the upstream channel access but have to wait in line behind clients with a lower upstream need 300.

With a prior method, clients returning to the queue after transmitting 310 were placed in the ordering sequence without regard to the upstream channel access need. Here, the returning client is placed at the end of the polling ordering. Newly active clients 320 on the network are placed next in the ordering to receive upstream access, again without regard to need for upstream access.

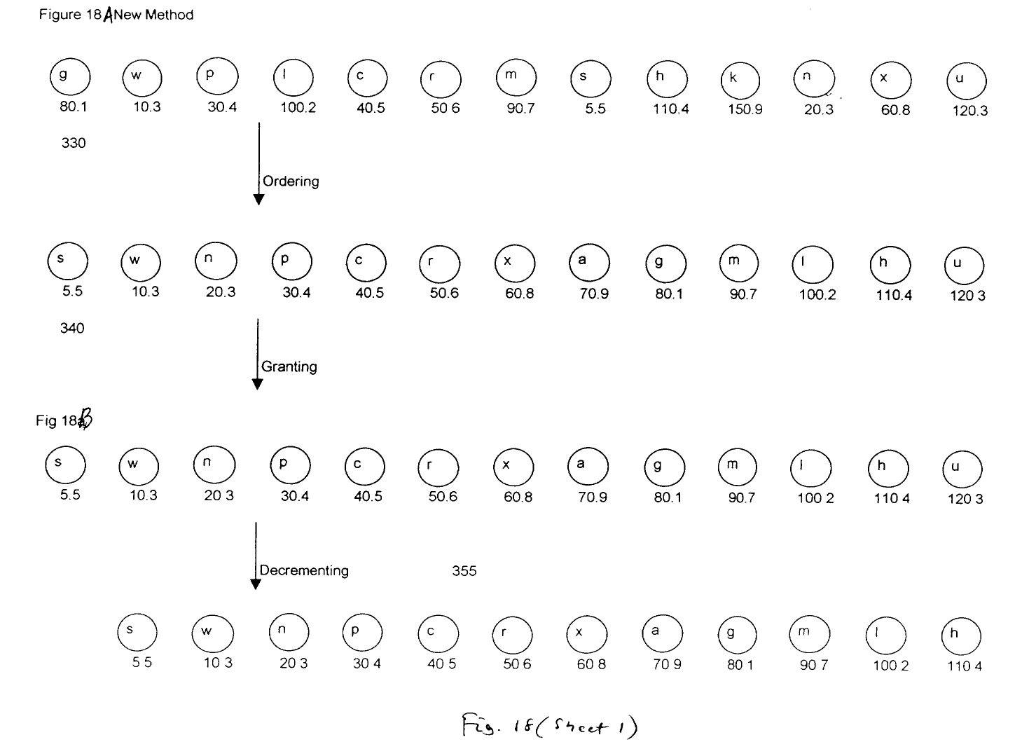

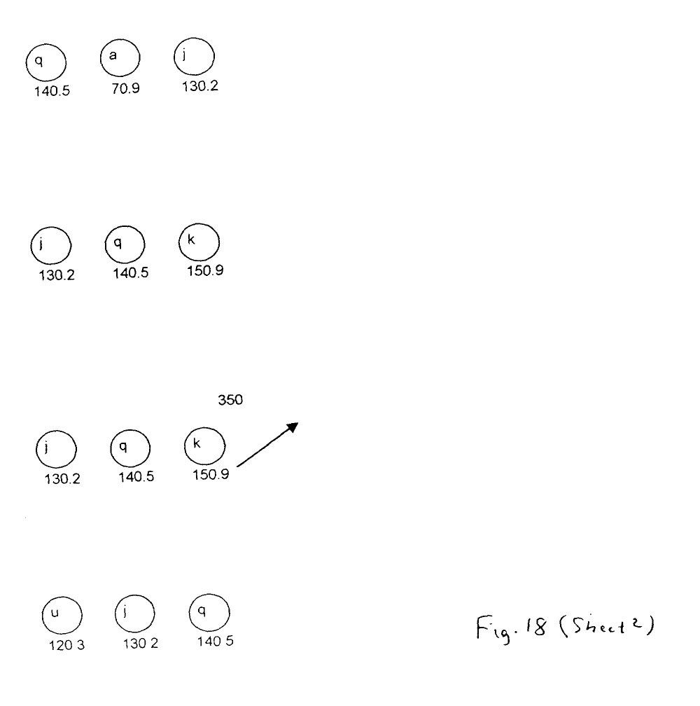

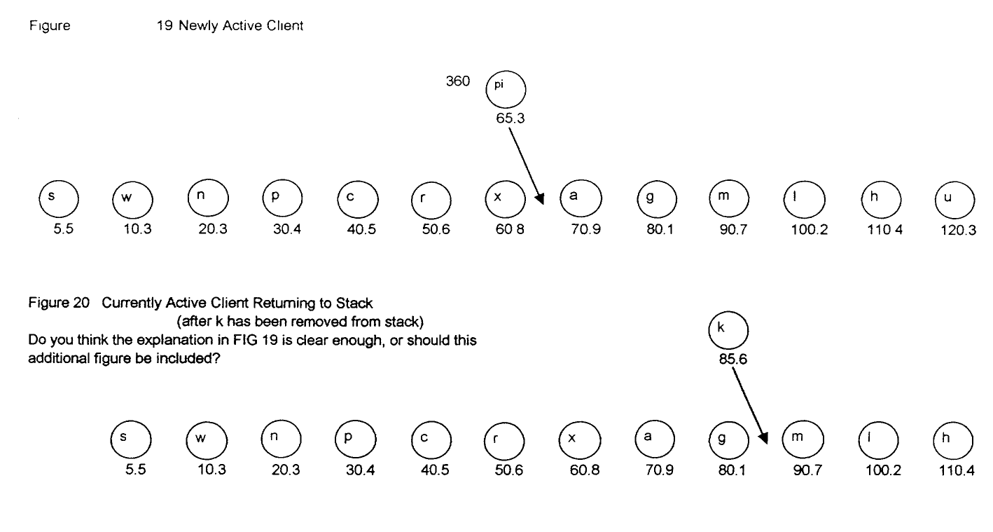

The improved method is illustrated in FIG. 18A and may be viewed more as a stack of clients 265 than a circle 260. For illustrative purposes, it is assumed that the improved method and previous method operates under similar conditions and variations. In this illustration of the improved method, the indication of need 330 is monitored, and the clients are ordered 340 according to this indication of need. Here, the embodiment of the improved method provides adjustment to the indications of data transmission needs of the clients and provides greater upstream grants of access for the clients requiring the grants. Simultaneously the embodiment of the improved method does not “over grant” those clients that do not indicate as great a need for upstream access.

In FIG. 18B the method provides granting the first client in the order 350 upstream channel access and, like the previous method, the grantee client 350 is removed from the ordering. In this illustration of the improved method, at a step 355, the remaining clients are decremented one position in the ordering.

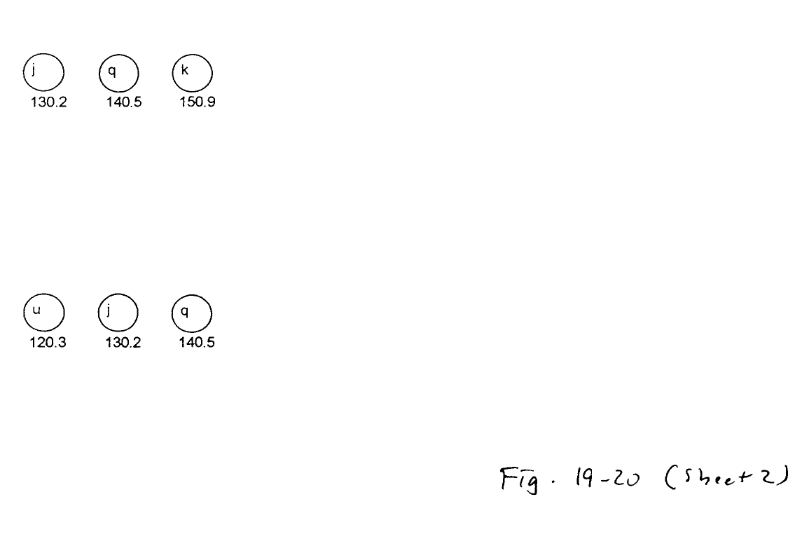

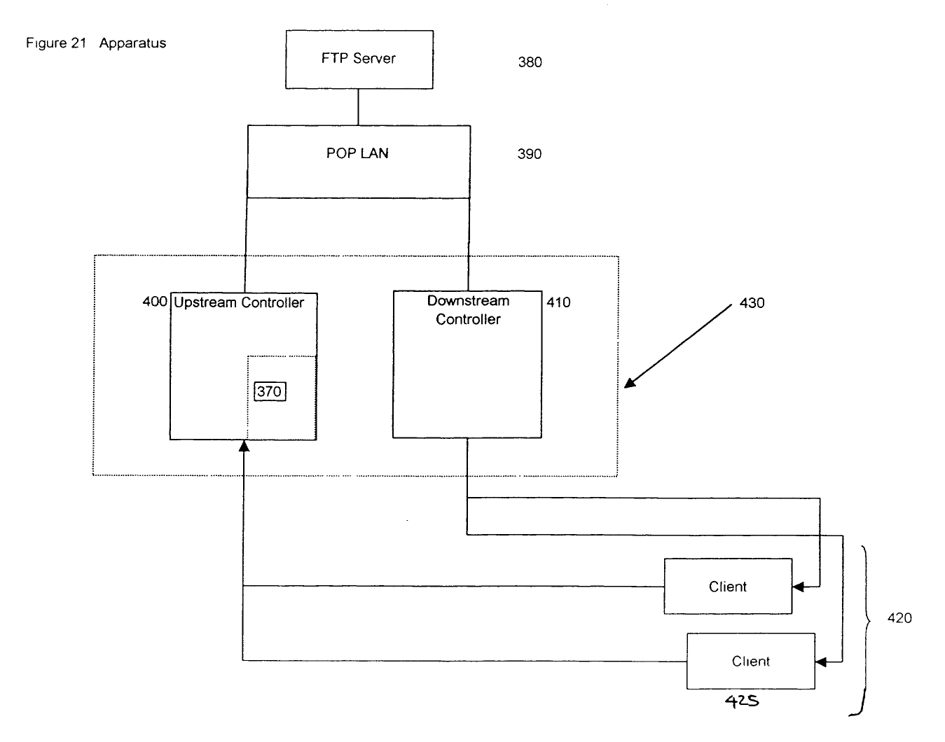

FIG. 19 illustrates an advantage of an aspect of the method for when a new client 360 appears in the ordering. The newly appearing 360 client, comprising a new client on the network 360 or a client returning from a transmission, is ordered according to its indication of need. Unlike certain prior polling methods, a finite upstream channel resource is more efficiently distributed by giving priority to the clients whose needs for upstream channel resources are greatest, and by doing so, the illustrative method enables a network to handle more clients using the same amount of resources.

For the special cases that arise, such as all clients having the same demand, or one client having a very low upstream demand during a period of heavy upstream use, a variety of fair access solutions may be utilized. For periods of heavy upstream use with one or more clients having a very low upstream need, periodical or random round robin access may also be provided as one solution. For a condition where all clients having the same demand, the arriving client to the ordering stack may be inserted at the end of the ordering stack. The aforementioned solutions are illustrative; many other solutions for the special situations are possible.

Various features of the apparatus embodiments is also described. FIG. 20 illustrates an embodiment of an apparatus 370 for controlling allocation of access (“the controller”) to a shared upstream channel in a network. In one embodiment, the network comprises a bi-directional communication network providing upstream and downstream data transfers of a plurality of clients 420 over said shared upstream channel, such as described in commonly-owned U.S. Pat. No. 5,586,121, incorporated herein. The upstream data transfer comprises data transferred between a plurality of clients 420 to a host 430. The downstream data transfer comprises data transferred between a host 430 to a plurality of clients 420. The host 430 controls the downstream and upstream transfer, the apparatus for controlling allocation comprises the host 430, wherein the controller 370 monitors the clients 420 to obtain indications of need of respective ones of the clients for upstream channel access, orders grants of upstream channel access to respective ones said clients based on said indications, grants upstream channel access to one client 425 according to the ordering of clients, and re-orders grants of channel access to respective ones of said client after controller 370 grants said one client 425 access to the shared upstream channel by repeating the monitoring, ordering and granting.

In yet another embodiment described by FIG. 20, the network comprises a POP LAN 390 switch connected to a FTP server 380. The POP LAN 390 is also connected to at least one upstream 400 and downstream 410 controllers. As illustrated in FIG. 20, the downstream 410 and upstream 400 controllers are connected to a plurality of clients 420. Should there be more description of the data transfers, for example, “upstream data transfer comprises data transferred between the plurality of clients and the upstream controller.” The controller 370 in this embodiment is included in the upstream controller 400. However, the controller 370 may be embodied in a variety of physical forms. For example, the controller may be a processor, microprocessor, microcontroller, or may be a part of a larger device such as a workstation, computer, personal computer, etc. The apparatus need not be contained in one device; it may be distributed among a plurality of physically separate devices.

The controller may also base its ordering on a time parameter, where the controller grants the clients with the smallest time allocation priority to upstream channel access. The previously mentioned time parameter may be a measurement of the time remaining to access the upstream channel kept by the apparatus.

In another embodiment of the apparatus, the indications the controller monitors include data transfer of respective ones of the clients and the ordering step includes the controller ordering the clients to receive grants of channel access based on a sliding window average. The sliding window average may be defined, for example, without limitation, as an instantaneous upstream data transfer or the controller may weigh the sliding window average according to whether the average is increasing or decreasing.

The apparatus may also contain internal hardware, such as a logic unit, etc. to facilitate the actions of the apparatus. Various memory devices and circuitry may also be present and embodied in a host of forms, for example RAM or ROM. Both the logic units and memory devices and circuitry may be separate, distributed, or combined with other aspects of the apparatus.

The apparatus may also have the controller monitor indications comprising average data transmissions of the clients, and the controller allocating a higher priority to clients having a higher average rate than clients having a relatively lower average.

In one of several embodiments of the apparatus, the controller monitors indications of need of the respective ones of the clients for upstream channel access that include information units transferred upstream by the clients or may include information units queued for upstream transfer.

The apparatus controller may also reorder the clients after a client granted upstream channel access actually completes an upstream data transfer. The controller may also decrement the position of the respective ones of the client in the ordering after granting upstream access to one of the clients to transmit data.

After granting upstream access to one of the clients to transmit data, the controller may also remove the granted client from the ordering of the respective ones of the client. In one arrangement of the apparatus, the controller returns the aforementioned previously removed client to the ordering when the client indicates a need for upstream channel access.

In another aspect of the apparatus, where the communication network includes at least one contention upstream channel on which multiple clients contend for authorization to obtain upstream channel access, the controller removes the client from the shared channel allocation to the contention channel after an inactivity of the client for a given period. In another arrangement of the apparatus, utilizing a similar contention channel structure on which multiple clients contend for authorization to obtain upstream channel access, the client removes itself from the shared channel to the contention channel after inactivity of the client for a given period.

Yet another embodiment of the apparatus may be found on a communication network that includes at least one dedicated upstream channel, and the apparatus controller removes a client from the shared channel allocation to the dedicated channel in response to a condition detected that requires a dedicated upstream channel. Additionally, an embodiment of the apparatus may be found wherein the network includes at least one contention upstream channel and at least one dedicated upstream channel, and the controller removes a client from a shared channel allocation to one of the contention and dedicated channels in response to a condition.

Yet another embodiment of the invention may also include where the clients transfer a representation of an information unit remaining for transfer upon the transfer of upstream data and the controller of the apparatus monitors the representations in order to produce the indications whereby the clients are ordered.

Accordingly, I claim:

1. In a bi-directional communication network that provides upstream data transfers for multiple clients over a shared upstream channel, a method of allocating access to said shared channel comprising:
(a) monitoring the clients to obtain indications of need of respective ones of the clients for upstream channel access,
(b) ordering grants of upstream channel access to respective ones of said clients based on said indications,
(c) granting upstream channel access to one client according to the ordering step, and
(d) re-ordering grants of channel access to respective ones of said client after said one client obtains access to the shared upstream channel by repeating steps (a) through (c).

2. The method as recited in claim 1, wherein said ordering is based on a time parameter allocated to the clients (e.g., by a controller) where a client with the smallest time allocation obtains priority to upstream channel access.

3. The method as recited in claim 2, wherein said time parameter allocated to the clients is a measurement of the time-to-access the upstream channel.

3. The method as recited in claim 1, wherein the indications in said monitoring step includes data transfer of respective ones of said clients and the ordering step includes ordering the clients to receive grants of channel access based on a sliding window average data transfer.

4. The method as recited in claim 3, wherein the sliding window average is defined as an instantaneous upstream data transfer.

5. The method as recited in claim 3, wherein the sliding window average is weighted according to whether the average is decreasing or increasing.

6. The method as recited in claim 1, wherein the indications of monitoring step include information units transferred upstream by said clients.

7. The method as recited in claim 1, wherein the indications of monitoring step include information units queued for upstream transfer.

8. The method as recited in claim 1, wherein the clients are ordered based on said indications for the grants of upstream channel access.

9. The method as recited in claim 1, wherein said re-ordering step includes re-ordering the clients after a client granted upstream channel access actually completes an upstream data transfer.

10. The method as recited in claim 1, wherein after said one client accesses the upstream channel to transmit data, decrementing position of said respective ones of said client in ordering.

11. The method as recited in claim 1, wherein said one client after obtaining access to shared upstream channel is removed from ordering of said respective ones of said clients.

12. The method as recited in claim 11 wherein said one client is returned to said ordering when said one client indicates a need for upstream channel access.

13. The method as recited in claim 1 wherein said communication network includes at least one contention upstream channel on which multiple clients contend for authorization to obtain upstream channel access, said method further comprising:
(e) removing a client from shared channel allocation to said at least one contention channel after inactivity of said client for a given period.

14. The method as recited in claim 1 wherein said communication network includes at least one dedicated upstream channel, said method further comprising:
(e) removing a client from shared channel allocation to said at least one dedicated channel in response to a condition detected that requires a dedicated upstream channel.

15. The method as recited in claim 1 wherein said communication network includes both at least one contention upstream channel and at least one dedicated upstream channel, said method further comprising:
(e) removing a client from shared channel allocation to one of said contention and dedicated channels in response to a condition.

16. The method as recited in claim 1, wherein said clients transfer a representation of information unit remaining for transfer upon transfer of upstream data, and said monitoring step includes monitoring said representation in order to produce said indications.

17. An apparatus that controls allocation of access to a shared upstream channel in a bi-directional communication network providing upstream and downstream data transfers for a plurality of clients, the apparatus including a controller that
(a) monitors the clients to obtain indications of need of respective ones of the clients for upstream channel access,
(b) orders grants of upstream channel access to respective ones of said clients based on said indications,
(c) grants upstream channel access to one client according to the ordering of the plurality of clients, and
(d) re-orders grants of channel access to respective ones of said client after controller grants said one client access to the shared upstream channel by repeating steps (a) through (c).

18. The apparatus as recited in claim 17, wherein the controller bases the ordering of said clients on a time parameter, the controller allocates to the clients where the controller grants a client with the smallest time allocation priority to upstream channel access.

19. The apparatus as recited in claim 18, wherein the time parameter provided by the controller assigns to the clients is a measurement of the time-remaining-to-access the upstream channel.

20. The apparatus as recited in claim 18, wherein the indications the controller monitors includes data transfer of respective ones of said clients and the ordering step includes ordering the clients to receive grants of channel access based on a sliding window average data transfer.

21. The apparatus as recited in claim 20, wherein the sliding window average is defined as an instantaneous upstream data transfer

22. The apparatus as recited in claim 20, wherein the controller weights the sliding window average according to whether the average is decreasing or increasing.

23. The apparatus as recited in claim 17, wherein the indications the controller monitors include information units transferred upstream by said clients

24. The apparatus as recited in claim 17, wherein the indications the controller monitors include information units queued for upstream transfer

25. The apparatus as recited in claim 17, wherein the controller orders the clients based on said indications for the grants of upstream channel access

26. The apparatus as recited in claim 17, wherein said controller reorders the clients after a client granted upstream channel access actually completes an upstream data transfer

27. The apparatus as recited in claim 17, wherein said controller, after granting upstream access to said one client to transmit data, decrements the position of said respective ones of said client in ordering

28. The apparatus as recited in claim 17, wherein said controller, after granting upstream access to said one client to transmit data, removes said one client from ordering of said respective ones of said client

29. The apparatus as recited in claim 28, wherein the controller returns said one client to said ordering when said one client indicates a need for upstream channel access

30. The apparatus as recited in claim 17, wherein said communication network includes at least one contention upstream channel on which multiple clients contend for authorization to obtain upstream channel access and the controller removes a client from shared channel allocation to said at least one contention channel after inactivity of said client for a given period

31. The apparatus as recited in claim 17, wherein said communication network includes at least one contention upstream channel on which multiple clients contend for authorization to obtain upstream channel access and a client removes itself from shared channel allocation to said at least one contention channel after inactivity of said client for a given period.

32. The apparatus as recited in claim 17, wherein said communication network includes at least one dedicated upstream channel, and the controller removes a client from shared channel allocation to said at least one dedicated channel in response to a condition detected that requires a dedicated upstream channel.

33. The apparatus as recited in claim 17, wherein said communication network includes both at least one contention upstream channel and at least one dedicated upstream channel, and the controller removes a client from a shared channel allocation to one of said contention and dedicated channels in response to a condition.

34. The apparatus as recited in claim 17, wherein said clients transfer a representation of information unit remaining for transfer upon transfer of upstream data, and the controller monitors said representations in order to produce said indications.
